(19) United States
(12) Patent Application Publication
(10) Pub. No.: US 2013/0159128 A1
(43) Pub. Date: Jun. 20, 2013

(54) SYSTEM AND METHOD FOR PROVIDING SECURITY IN VARIABLE TIME-BASED LICENSING SYSTEMS

(71) Applicants: Yorgos Koutsoyannopoulos, Athens (GR); Anand Raman, Campbell, CA (US); Sotirios Bantas, Athens (GR); Apostolos Liapis, Athens (GR); Christos Makiyama, Yokohama (JP); Nikolas Provatas, Piraeus (GR)

(72) Inventors: Yorgos Koutsoyannopoulos, Athens (GR); Anand Raman, Campbell, CA (US); Sotirios Bantas, Athens (GR); Apostolos Liapis, Athens (GR); Christos Makiyama, Yokohama (JP); Nikolas Provatas, Piraeus (GR)

(73) Assignee: HELIC S.A., Athens (GR)

(21) Appl. No.: 13/325,702

(22) Filed: Dec. 14, 2011

(51) Int. Cl. G06Q 30/02; G06F 21/22

(52) U.S. Cl. 705/26.2; 726/27

(57) ABSTRACT

A system and method for a software licensing system for use in e.g., a variable time-based licensing, is provided. Such a system includes a secure device, including a first computer readable medium, configured to connect to a computer, including a second computer readable medium and microprocessor. The secure device can further include a chips pool which stores inactive chips, and a chips accounting manager, operable to receive license requests for software tools and to determine whether to grant the license request. In this context “chips” can be considered a currency which can be traded to use software tools for a period of time associated with each chip. The system further includes a license server, executing on the computer. The license server can include a license manager which tracks active chips and manages activated chip check-in and checkout, and a chips cache which stores activated chips.

### CLAIM OF PRIORITY

This application claims the benefit of priority to:

U.S. Provisional Patent application titled “SYSTEM AND METHOD FOR VARIABLE TIME-BASED LICENSING”, Application No. 61/346,346, filed May 19, 2010, and incorporated herein by reference; and

U.S. Patent Application titled “SYSTEM AND METHOD FOR VARIABLE TIME-BASED LICENSING”, application Ser. No. 13/105,772, filed May 11, 2011, and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the present invention are generally related to electronic design automation (EDA) software licensing and license managers, and particularly to a system and method for providing security in variable time-based licensing systems in an EDA or other environment.

### BACKGROUND

Electronic Design Automation (EDA) tools are software tools used to design electronic systems including chips and circuits. Traditionally, circuit design firms would purchase EDA tools, like most software tools, outright. This model, in which the EDA tool is viewed as an asset, has been subsequently largely replaced by a time-based license (TBL) model, in which the EDA tool was essentially leased to the design firm. A design firm would purchase licenses from the EDA tool developer and then allocate these licenses for use among the design firms various development teams. As long as a license was available, a user in the firm could access the software as needed and then return the license to a license pool so that other users in the firm could use the software.

However, a firm's design cycle often does not yield uniform usage of EDA tools. Instead, a firm may experience periods where no licenses are used, and other periods where there is demand for additional licenses above the number of licenses purchased. Thus, design firms generally plan to purchase enough licenses to satisfy average demand over the course of a contract period (e.g., a year), to attempt to minimize both the losses associated with underutilized licenses and the inconvenience associated with increased demand during peaks of the design cycle.

FIG. 1 shows a chart of Concurrent Licenses Used under the TBL Model as a function of time. In the example of FIG. 1, the curve 100 illustrates the number of licenses used (or demanded) at any given time, while number of licenses purchased is represented by dotted line 102. The area under the curve 104 represents the time during which the EDA tools are actually being utilized. Over the course of the exemplary design cycle shown in FIG. 1, there are two peak periods 106 in which demand for licenses exceeds the number of licenses purchased, resulting in unfulfilled demand. Additionally, there is one period 108 during which all licenses are sitting idle.

It is clear that the TBL model which currently dominates the EDA software market produces inefficiencies for both the customer and the software developer by providing coarse grained controls that cannot be easily adapted to the natural design cycles of design firms.

### SUMMARY

In accordance with an embodiment, a system and method for a software licensing system for use in e.g., a variable time-based licensing, is provided. Such a system includes a secure device, including a first computer readable medium, configured to connect to a computer, including a second computer readable medium and microprocessor. The secure device can further include a chips pool which stores inactive chips, and a chips accounting manager, operable to receive license requests for software tools and to determine whether to grant the license request. In this context “chips” can be considered a currency which can be traded to use software tools for a period of time associated with each chip. The system further includes a license server, executing on the computer. The license server can include a license manager which tracks active chips and manages activated chip check-in and checkout, and a chips cache which stores activated chips.

### BRIEF DESCRIPTION OF THE FIGURES

FIG. 1 shows a chart of Concurrent Licenses Used under the TBL Model as a function of time.

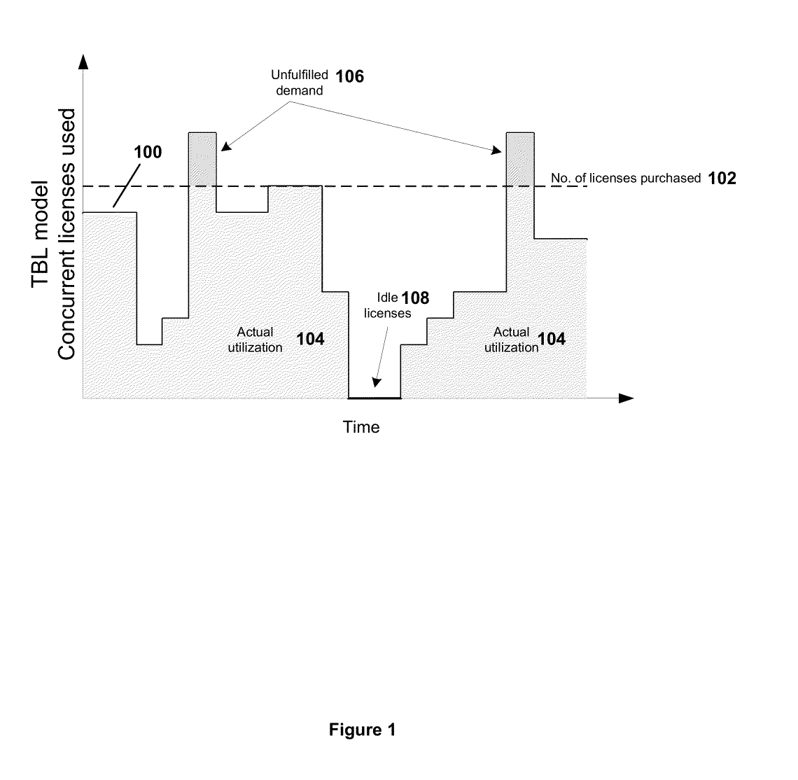

FIG. 2 shows a chart of Concurrent Licenses Used for a High Speed Modeling (HSM) Tool under the TBL Model as a function of time.

FIG. 3 shows a block diagram of a VTBL system, in accordance with an embodiment of the invention.

FIG. 4 shows a flow chart illustrating a method of managing chips by a chips accounting manager, in accordance with an embodiment of the invention.

FIG. 5 shows a flow chart illustrating a method of managing chips by a chips accounting manager, in accordance with an embodiment of the invention.

FIG. 6 shows an audit function, in accordance with an embodiment of the invention.

FIG. 7 shows an exemplary graphical user interface associated with the licensing system, in accordance with an embodiment of the invention.

FIG. 8 shows a chips utilization example, in accordance with an embodiment of the invention.

FIG. 9 shows an example of a utilization bonus, in accordance with an embodiment of the invention.

FIG. 10 shows an example of a chip security system, in accordance with an embodiment of the invention.

FIG. 10a shows an alternative example of a chip security system, in accordance with an embodiment of the invention.

FIG. 10b shows an alternative example of a chip security system, in accordance with an embodiment of the invention.

FIG. 11 shows a method for managing chips by a broker, in accordance with an embodiment of the invention.

### DETAILED DESCRIPTION

In accordance with an embodiment, a system and method for variable time-based licensing is provided, which includes a chips cache which stores activated chips and a chips pool which stores inactive chips. In this context “chips” can be considered a currency which can be traded to use software tools for a period of time associated with each chip. The system further includes a chips accounting manager, operable to receive license requests for software tools and to determine whether to grant the license request; and a license manager which tracks active chips and manages activated chip check-in and checkout. When the chips accounting manager receives a license request for a software tool the chips accounting manager determines whether the chips cache includes sufficient chips to access the software tool. If there are insufficient chips, the chips accounting manager checks whether inactive chips in the chip pool can be activated and added to the chips cache. If there are sufficient chips, the chips accounting manager notifies the license manager to check out the sufficient chips from the chips cache and grant access to the software tool.

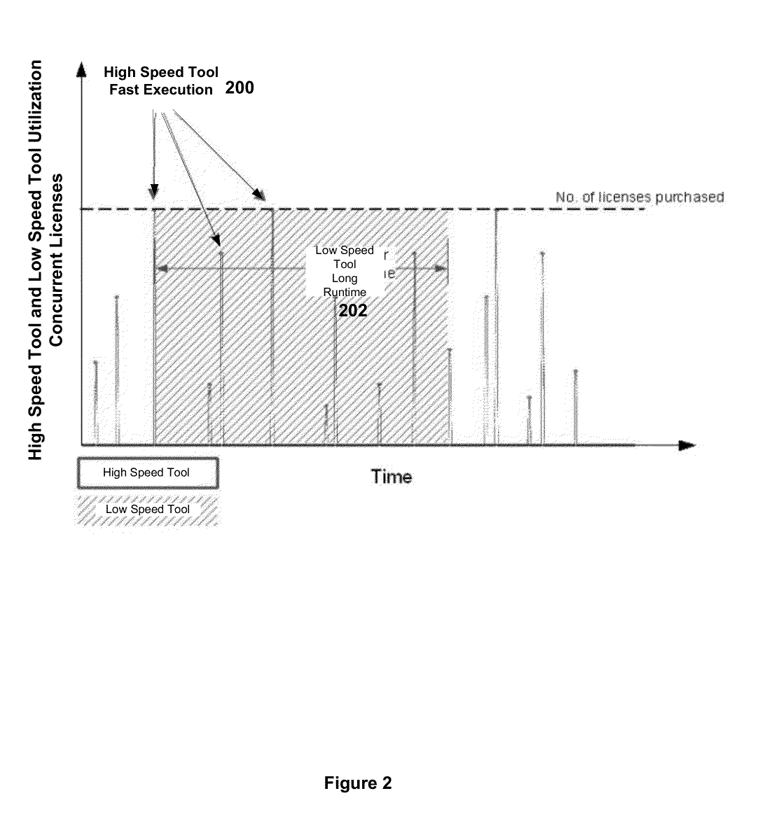

FIG. 2 shows a chart of Concurrent Licenses Used for a High Speed Tool and a Low Speed Tool under the TBL Model as a function of time. As shown in FIG. 2, a high speed tool generally executes more quickly than a traditional low speed tool, so its utilization curve can be seen as a series of brief spikes 200. Performing the same operations using a traditional low speed tool can require a significantly greater utilization period, as illustrated by block 202. Under the TBL model, a firm is incentivized to purchase fewer licenses of the high speed tool over the course of a contract period (e.g., a year), based on the speed at which the high speed tool operates. The TBL model ignores how productive a given tool is and instead only values how often the tool is used. Thus, high speed tools are effectively penalized under TBL as compared to lower speed tools. This applies to any area in which a vendor licenses a tool on a time basis, such as Computer Aided Design (CAD), data analytics and EDA tools, among others.

In accordance with an embodiment, and unlike traditional TBL systems which granted a certain number of licenses that can be used at a given time, a contract for a given contract period (e.g., a year) under a VTBL system can specify a number of chips. Chips can be stored for the contract period until needed by the firm. The chips can then be activated on demand by the firm to access one or more software tools, with each chip expiring after a predetermined time after activation. Each software tool can require a predetermined number of chips to be utilized, depending on factors specific to that software tool such as the complexity of operations that can be performed by the software tool, or the productivity of the software tool.

For example, consider the situation in which firm A wants three of its employees to use Tool 1 to work on a project. Under the TBL system, firm A can check how many licenses it has for Tool 1 and then schedule its employees accordingly (e.g., if they have two licenses they could stagger their employees hours so that only two of the employees are using Tool 1 at any given time). This employment schedule would continue until the project is complete.

However, in accordance with an embodiment, under a VTBL system, firm A can check how many chips Tool 1 requires. For example, if Tool 1 requires one chip per user, and each chip lasts one week, then firm A can allocate three chips so that each of the three employees can work simultaneously. Thus, firm A is not bound by a predetermined number of licenses. When demand increases, they can activate more chips and when demand decreases they can activate fewer chips. Since each chip lasts for a predetermined amount of time (e.g., a week), the amount of time a chip is idle, and therefore wasted, is greatly reduced as compared with TBL.

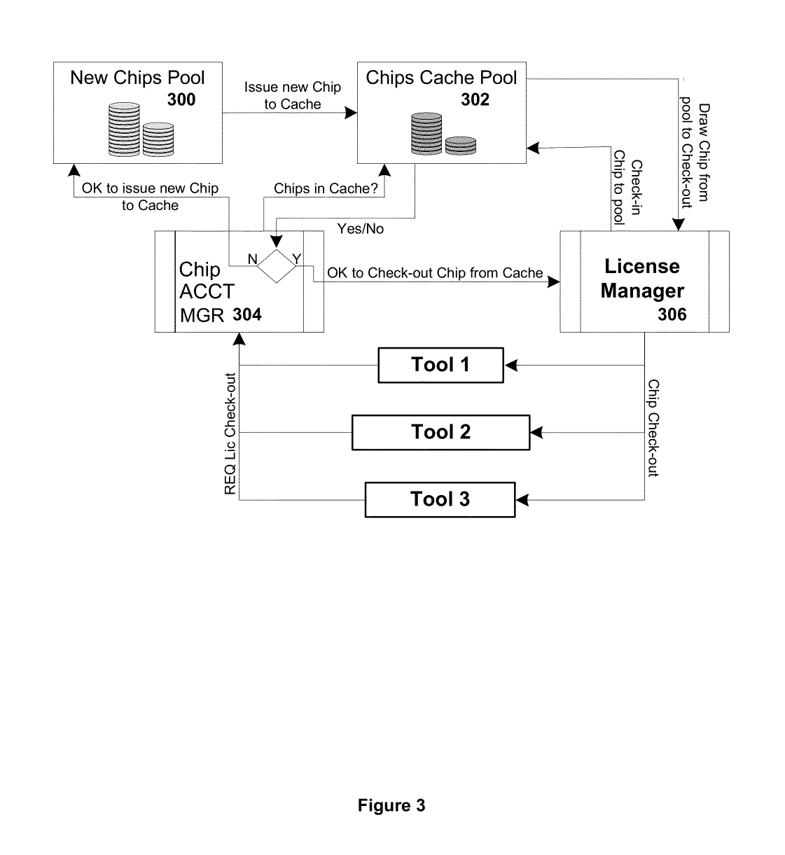

FIG. 3 shows a block diagram of a VTBL system, in accordance with an embodiment. As shown in FIG. 3, a contract can specify a number of chips available to a customer during the contract period. In accordance with an embodiment, the contract period can be any period of time, as specified by the contract. Often contracts are negotiated on a yearly basis, leading to a one year contract period. Chips, or combinations of chips, can be used by the customer to utilize software tools. The chips specified in the contract, referred to as new chips, are stored in a new chips pool 300. These new chips last for the duration of the contract period or until they are consumed.

In accordance with an embodiment, when new chips are consumed, their status changes from new chips to activated chips, and the activated chips are stored in the chips cache pool 302. Once activated, activated chips last for a limited period of time, for example one week. Activated chips, or combinations thereof, can be used to by the customer to use software tools. Once the customer finishes using the software tool, if the activated chips are still active, then they are returned to the chips cache pool and can be used again by the customer to reuse the software tool, or a different software tool.

In accordance with an embodiment, the new chips pool and the chips cache pool can be implemented as a single chip pool which tracks chip consumption and activation, and makes chips available as specified by the contract in view of current consumption.

In accordance with an embodiment, when a customer requests access to a tool (such as tool 1, tool 2, or tool 3) a chips accounting manager 304 checks whether sufficient chips are available in the chips cache pool. If there are sufficient chips, then the chips accounting manager passes the request to the license manager 306 which draws the necessary chips from the chip cache pool and grants access to the requested tool.

If, instead, there are insufficient chips to complete the request, then the chips accounting manager determines whether new chips can be activated from the new chips pool and added to the chips cache pool. If new chips can be activated, then enough new chips are activated to bring the total number of activated chips in the chips cache pool to the minimum required to complete the request. The request is then forwarded to the license manager which draws the necessary chips from the chips cache pool and grants access to the requested tool.

In accordance with an embodiment, if there are insufficient chips in the chips cache pool and new chips cannot be activated, then the request is denied, and an explanatory message is displayed to the user.

In accordance with an embodiment, the chips accounting manager and the license manager, shown in FIG. 3, can be provided as a single chips accounting and license manager. The chips accounting and license manager is operable to receive license requests for software tools, determine whether to grant the license request, track activated chips, and manage activated chip check-in and checkout. Additionally, when the chips accounting and license manager receives a license request for a software tool, the chips accounting and license manager determines whether the chips cache includes sufficient chips to access the software tool. If there are insufficient chips, the chips accounting and license manager checks whether inactive chips in the chips pool can be activated and added to the chips cache, and if there are sufficient chips, the chips accounting and license manager checks out the sufficient chips from the chips cache and grants access to the software tool.

In accordance with an embodiment, a chips accounting manager, such as that shown in FIG. 3, can be incorporated into a VTBL system that already includes a license manager. The chips accounting manager is operable to receive license requests for software tools and to determine whether to grant the license request. In this embodiment, the chips accounting manager includes a first interface to communicate with a chips pool and a chips cache, and a second interface adapted to communicate with the preexisting license manager in the VTBL system. When the chips accounting manager receives a license request for a software tool, the chips accounting manager determines, using the first interface, whether the chips cache includes sufficient chips to access the software tool. If there are insufficient chips, the chips accounting manager checks, using the first interface, whether inactive chips in the chips pool can be activated and added to the chips cache. If there are sufficient chips, the chips accounting manager notifies, using the second interface, the license manager to check out the sufficient chips from the chips cache and grant access to the software tool.

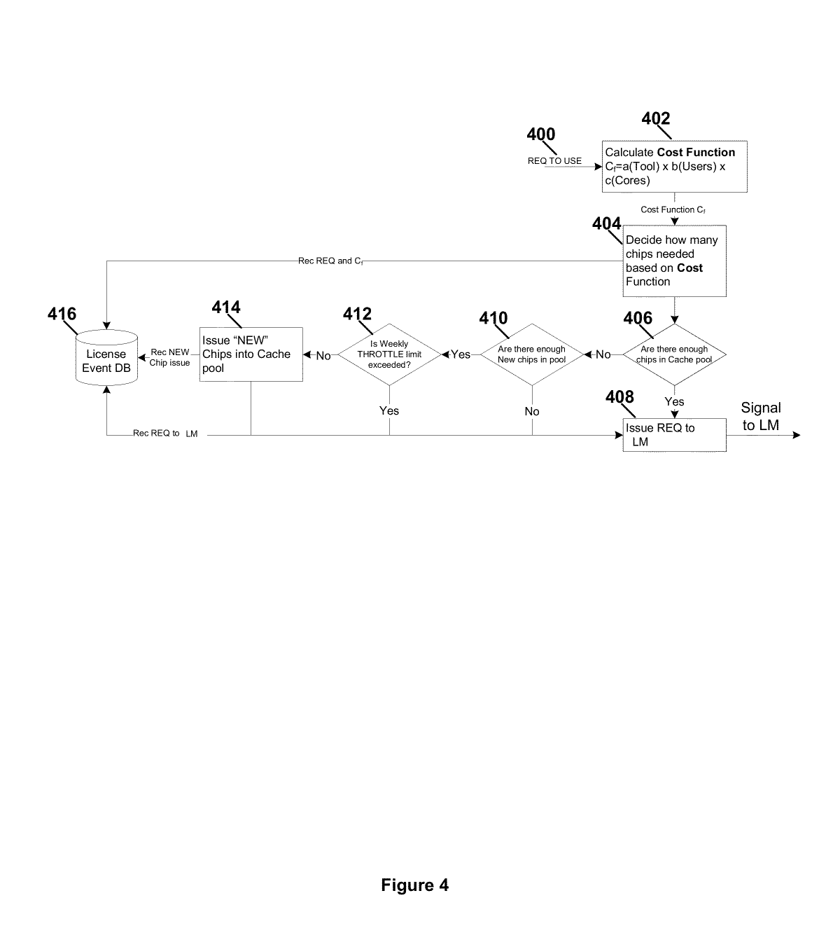

FIG. 4 shows a flow chart illustrating a method of managing chips by a chips accounting manager, in accordance with an embodiment. At step 400, a request for a particular tool is received. At step 402, a cost function is calculated for the problem being solved. In accordance with an embodiment, the cost function can consider several factors, including, for example, the tool being requested, the number of processor cores that will be utilized, and the number of users that will be using the tool. The factors can be equally weighted or each factor can be differently weighted, as needed. At step 404, the cost function is used to determine how many chips are needed to complete the request. At step 406, the system determines whether there are enough chips in the chips cache pool. At step 408, if there are enough chips, then the request is forwarded to the license manager to complete.

At step 410, if there are not enough chips in the chips cache pool, then it is determined whether there are enough chips in the new chips pool. If there are not enough new chips, then processing proceeds to step 408 and the request is forwarded to the license manager (LM). The license manager will then deny the request and can inform the customer that there are insufficient chips.

At step 412, if there are sufficient chips in the new chips pool, then it is determined whether any consumption limits are in place. For example, the customer can set a throttle limit, which limits the rate of consumption over a given period of time. If the throttle limit, or another consumption limit has been reached or exceeded, then processing returns to step 408 and the request is forwarded to the license manager. The license manager will then deny the request and can inform the customer that the consumption limit has been reached. The license manager can also provide the user with instructions for changing the consumption limit.

At step 414, if the consumption limit has not been reached, then enough new chips to service the request are activated and stored in the chips cache pool. At step 416, a license event database receives the request to activate new chips, and activates the new chips. Processing then returns to step 408 and the request is forwarded to the license manager to complete. The license event database can also be used to audit chip usage and consumption which can include a number of diagnostic measurements and other performance metrics that can be provided to the customer.

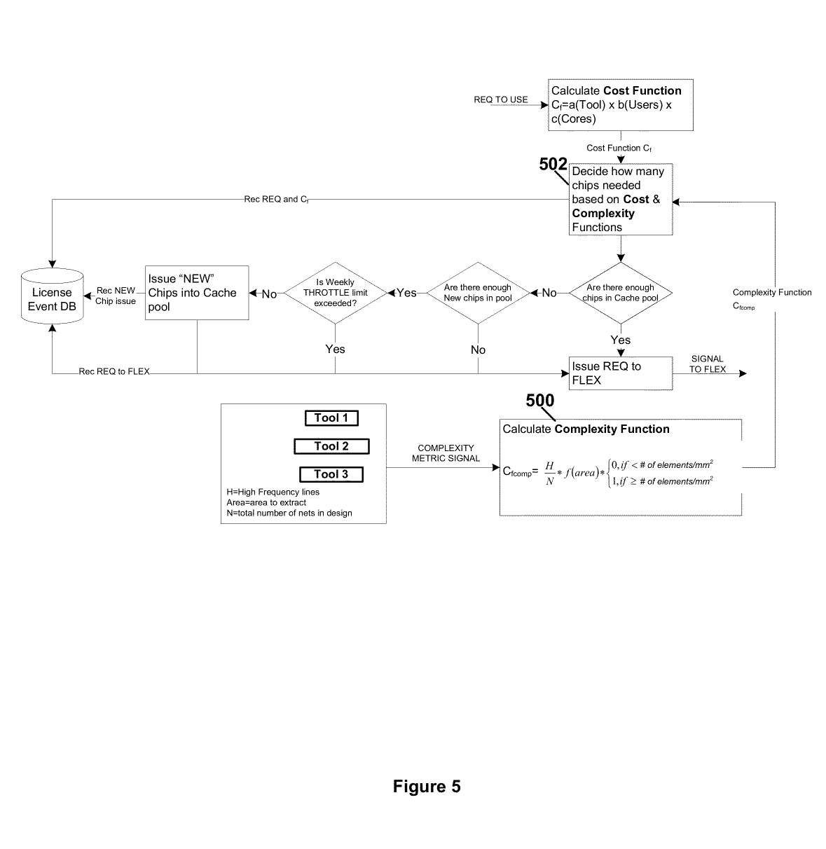

FIG. 5 shows a flow chart illustrating a method of managing chips by a chips accounting manager, in accordance with an embodiment. Processing in FIG. 5 proceeds similarly to that in FIG. 4; however, in addition to a cost function, at step 500 a complexity function is also calculated. In accordance with an embodiment, the complexity function can be based on the tool being used and the complexity of the operation to be performed. For example, simple operations can have a small or zero complexity function, which would minimally affect the number of chips required; while complex operations can have a large complexity function which requires additional chips. An example of one such complexity function is shown in FIG. 5. Although the example shown in FIG. 5 is based on the use of an EDA tool, this is merely one example, and is provided for ease of explanation. One of ordinary skill would recognize that any number of cost functions can be developed on an application by application basis, depending on the tools used and the operations performed. As shown in FIG. 5, one such cost function can include a ratio of high frequency lines (H) to total number of nets in the design (N), multiplied by a function describing the area to be extracted (f(area)). This formula is then applied in a binary manner, depending on the complexity. If the value for H/N*f(area) is greater than a cutoff value, then it serves as the complexity function. If, however, the value for H/N*f(area) is less than a cutoff value, then the design is simple enough that no complexity function need be considered when determining how many chips are required.

At step 502, the number of chips required is determined based on the complexity function and the cost function. The remaining steps proceed similarly to the corresponding steps described above with respect to FIG. 4.

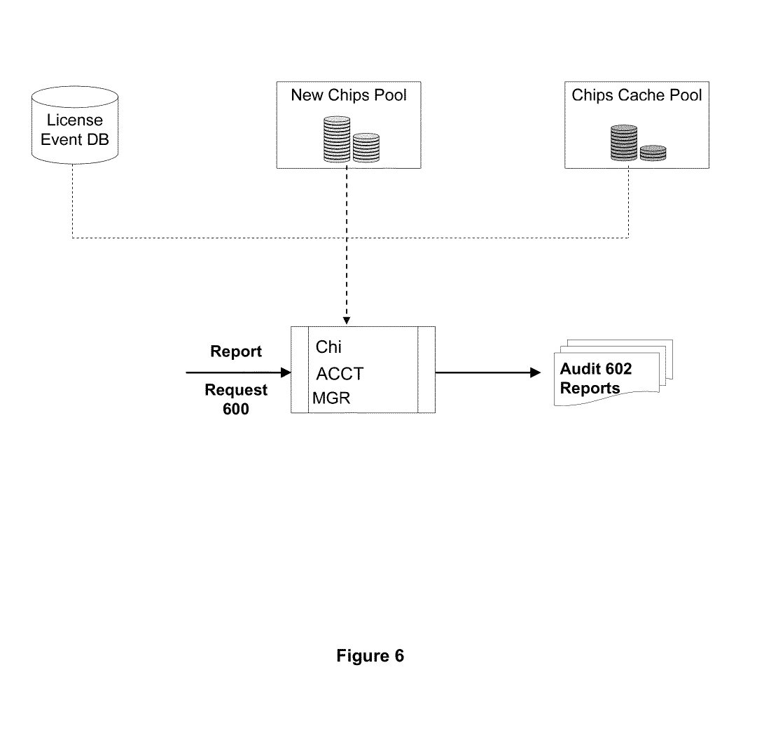

FIG. 6 shows an audit function, in accordance with an embodiment. Audit reports can be requested 600 by the customer through the chips accounting manager. The chips accounting manager can retrieve information from various data sources including the license event database, new chips pool, and chips cache pool, and then compile audit reports which can be provided to the customer 602.

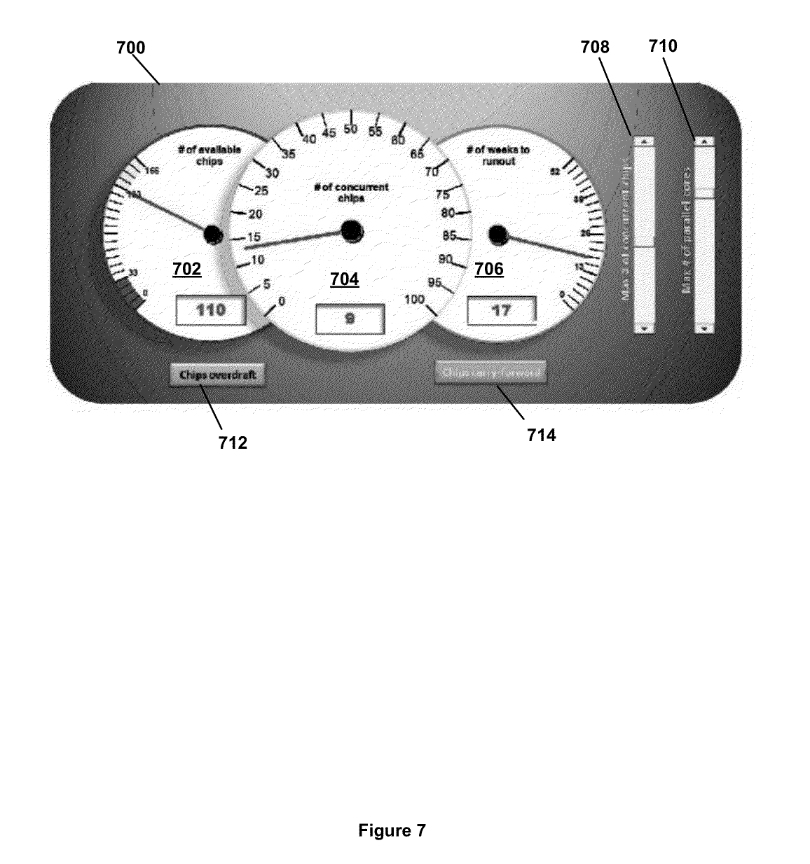

FIG. 7 shows an exemplary graphical user interface (GUI) associated with the licensing system, in accordance with an embodiment. The GUI 700 can serve as a dashboard or cockpit for the customer, providing an overview of current usage, projected usage, and controls for regulating and auditing usage. In the example shown in FIG. 7, three dials are displayed to the user representing the number of chips available 702, the number of concurrent chips 704, and the number of weeks to runout 706. The GUI can communicate with the software licensing system to determine these metrics. Additionally, the GUI displays two slider controls controlling a maximum number of concurrent chips 708 and a maximum number of parallel cores 710. The GUI also displays selectable buttons or icons which indicate chip overdraft settings 712 and chip carry-forward status 714.

In accordance with an embodiment, the number of concurrent chips shows the number of chips that are currently in use by the customer. This can be configured to show the number of chips currently withdrawn and activated, including both chips currently being used to provide access to a software tool and those in the chips cache pool but currently not in use. The number of chips available shows the number of chips in the new chips pool, i.e., the number of chips specified in the contract less the chips which have been activated and/or consumed. The number of weeks to runout estimates how long the new chips will last based on current consumption. The estimate can use an average of consumption over a particular period of time such as the average over the time that the current contract has been in place or the average over the previous month or based on instantaneous usage. Additionally, multiple estimates based on different averages can be provided to the customer in the GUI.

In accordance with an embodiment, the GUI also provides the customer with usage controls that can be used to regulate the customer's chip usage, such as the slider controls shown in FIG. 7. If the customer notices that chip usage is higher than expected, the customer can reduce the number of chips that can be used at any given time which can reduce the rate at which chips are activated and consumed. Additionally, the customer can reduce the number of parallel cores used to execute the software tools. This can similarly reduce the number of chips activated and consumed. Accordingly, the inputs received from the customer can then be used to control the underlying software licensing system to control the rate at which chips are activated and consumed.

In accordance with an embodiment, additional information can be provided to the user through the GUI, such as chips overdraft and chips carry-forward. Chips overdraft can enable the customer to add additional new chips, above the contract-specified number, in accordance with the contract. For example, a customer who buys M chips can be provided the option of purchasing up to an additional N % of M in overdraft chips. Similarly, chips carry-forward can show the customer how many chips of the originally purchased chips can be carried over to a new contract period, if not consumed during the current contract period.

It will be evident that the above example GUI is provided for purposes of illustration and that in accordance with other embodiments, other GUIs can be used and that the GUI is not restricted to the precise examples shown and described above.

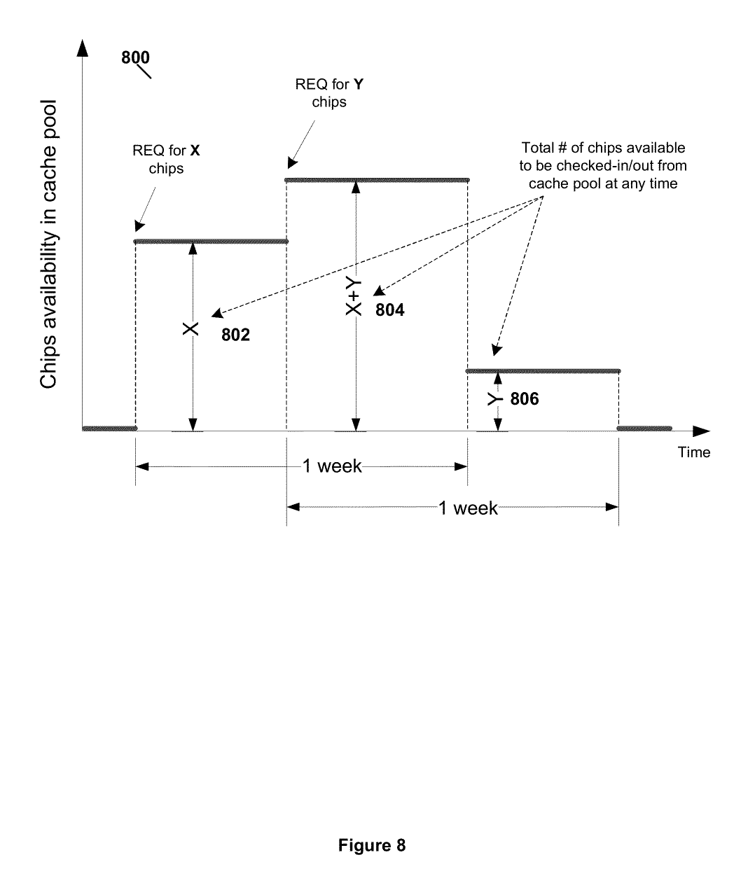

FIG. 8 shows a chips utilization example, in accordance with an embodiment. In FIG. 8, chip availability is graphed versus time 800, showing the number of chips available at any given time. In this example, a request to use a software tool is received, and it is determined that this request requires X chips to be completed. Assuming there are currently zero chips in the chips cache pool, then X chips are activated and stored in the chips cache pool 802. In this example, activated chips expire after one week. As such, these X chips are available for one week, and then are no longer available. After use of the software tool is complete, the chips are returned to the chips cache pool until they are either reused or they expire.

If a second request is received which requires Y chips, and the X chips are in use, then an additional Y chips can be activated and added to the chips cache pool. This brings the total chips stored in the chips cache pool to X+Y 804. When the X chips expire, they are deactivated and removed from the chips cache pool, leaving only the Y chips behind 806. The remaining Y chips will remain in the chips cache pool again until they are either reused or they expire.

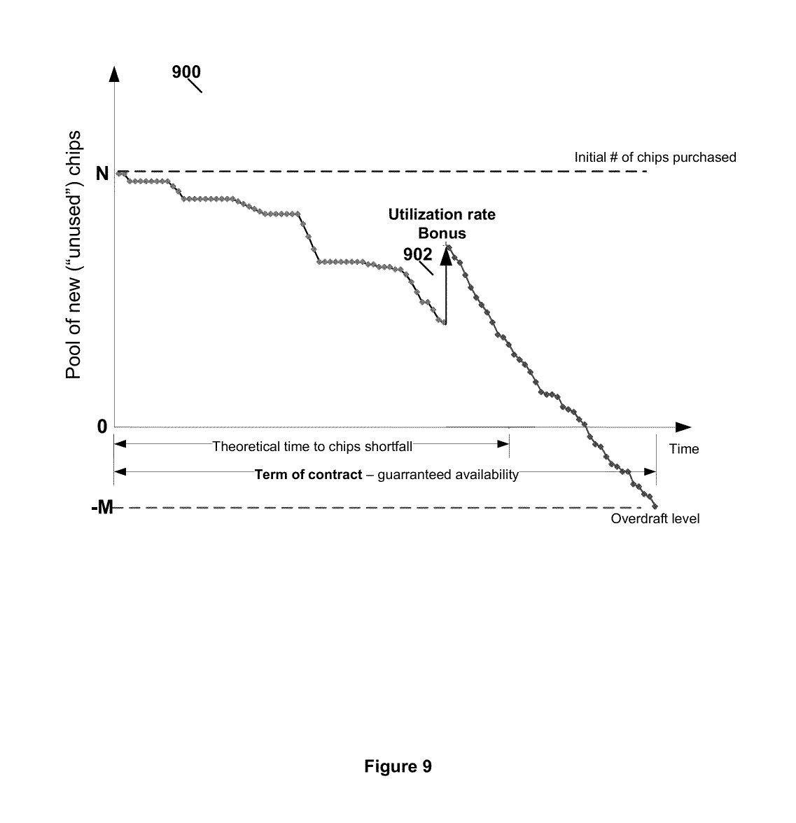

FIG. 9 shows an example of a utilization bonus, in accordance with an embodiment. In FIG. 9, a graph 900 is shown of chips in the new chips cache over time. At time zero, there are N chips in the new chips cache, the value of N is specified by contract with the customer. Additionally, the contract specifies an overdraft amount of M chips. As such, over the course of the contract, the customer has N+M chips available for use. If, during the contract period, it is determined that the customer is likely to run out of chips before the end of the contract period, a usage bonus can be applied to the customer's account. A one time deposit, as shown at 902, can be added to extend the projected runout time to the end of the contract period. This one time deposit can be added at the discretion of the software tool developer, the license manager, or specified in the contract based on various usage metrics and actual consumption rates.

### Chip Security

In accordance with an embodiment, a chip security system can be used to protect against the misuse of chips, even at the site of an authorized user, and provide a secure means of transferring or trading chips between different users. As described above, a VTBL system can include a new chip pool, which includes those chips which have not been activated, and a chip cache pool which includes activated chips. Typically, the license manager includes basic security checks to make sure that activated chips, stored in the chip cache pool, expire appropriately. An additional security mechanism can be used with the chip accounting manager to ensure that the new chip pool accurately reflects the number of purchased chips that have not been activated, has not been tampered with and does not include any counterfeit chips.

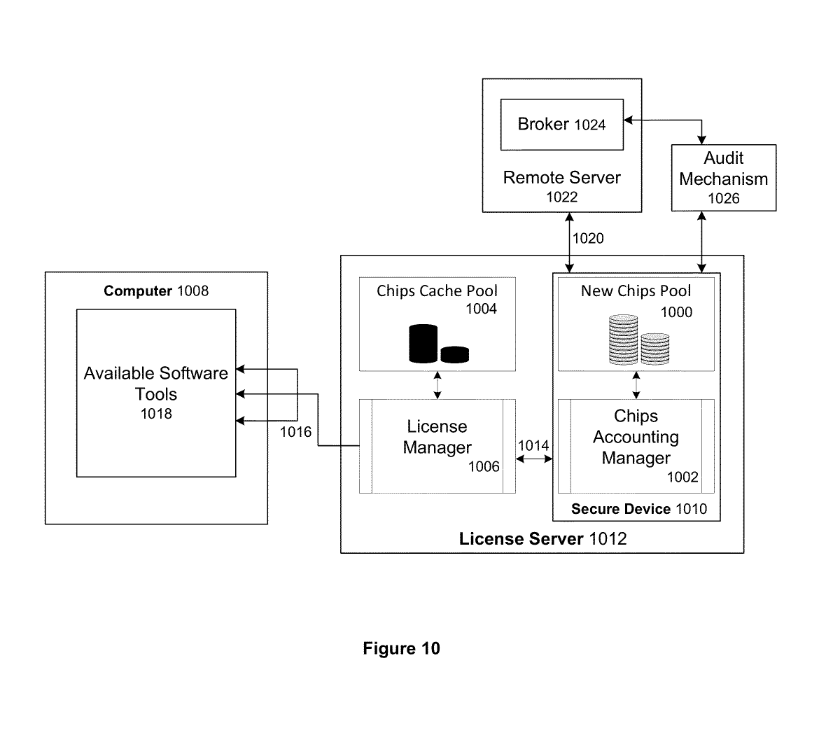

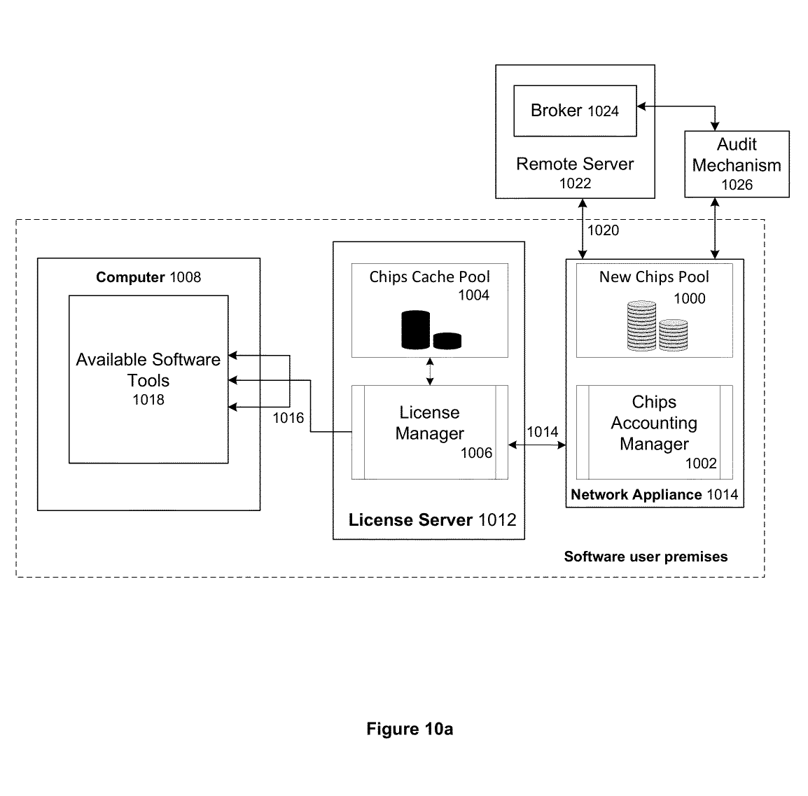

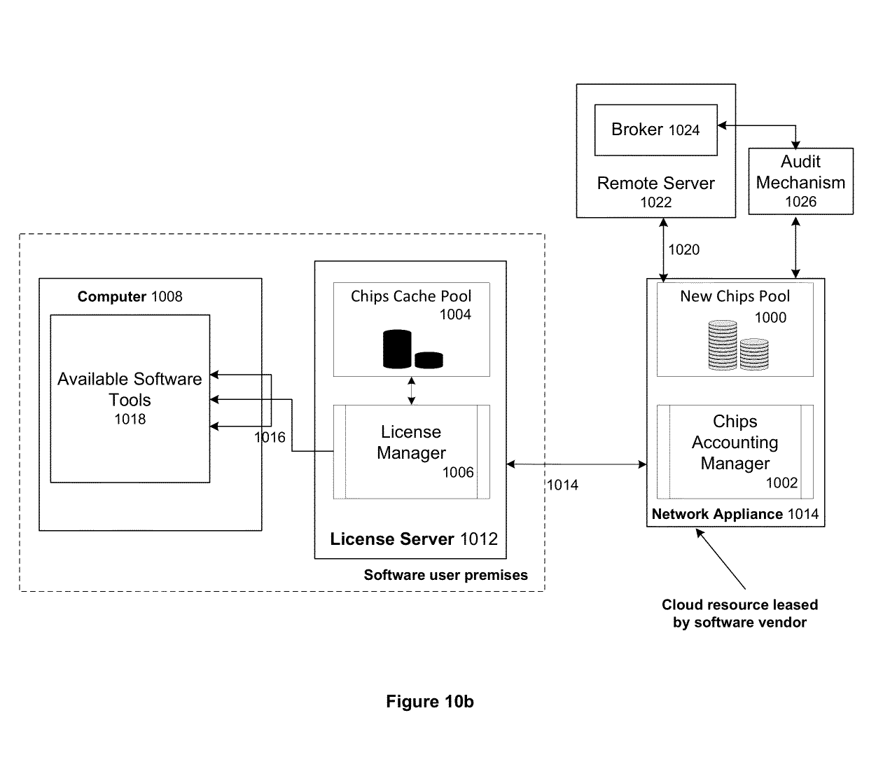

FIG. 10 shows an example of a chip security system, in accordance with an embodiment. As shown in FIG. 10, a user can access various software tools on his computer, through a license server. As described above, a VTBL system can include a new chips pool 1000, a chip accounting manager 1002, a chips cache pool 1004, and a license manager 1006. In accordance with an embodiment, these components of the VTBL system can be distributed across multiple computers and/or servers. For example, the user's computer 1008 can have access to a secure device 1010 which includes the chip accounting manager and the new chips pool. The secure device can be a hardware device which connects to the license server 1012 through a standard port (such as USB) or a software device which executes, or is stored on the license server 1012 where the license manager 1006 runs and is accessed through the local network. The chips cache pool 1004 and the license manager 1006 can be provided also on the license server 1012. These components of the VTBL system can then communicate 1014, as described above, when the user requests access to a particular software tool. The license manager 1006 can accordingly provide access 1016 to one or more of the available software tools 1018. The secure device 1010 can be substituted by a network appliance 1014 which is an independent computer connected to the same local area network as the license Server 1012 and be accessed through the same network (FIG. 10a). As a third option, the network appliance 1014 can become a network appliance or virtual machine that runs on a remote server, stored on the internet cloud, as in an internet cloud device located for example on a remote server farm (FIG. 10b). This virtual machine is a cloud resource leased by the software vendor and communicates 1020 with the broker 1024 to perform the audit mechanism 1026 by accessing the internet.

In accordance with an embodiment, the secure device 1010, such as a secure hardware device like a USB dongle, includes a memory and software which are not accessible or changeable by an end user. A secure file or software system could be used in addition, or in the alternative, to the secure hardware device. However, a secure hardware device includes the added benefit of being more difficult to duplicate compared to a file or software system. A secure hardware device can be delivered to the end user encrypted with a security key (e.g., a 128 bit security key) which is associated with the issuer of the device. The device can come preprogrammed with an initial number of chips purchased and cannot be directly be adjusted by the user. Instead, the user can update the device by connecting it to a remote server, such as a software tool-specific or independent broker, which can then update the device using the encryption key for that issuer. When used with computers that are not connected to the internet, the secure hardware device will be unable to connect to the remote server to be updated. The secure hardware device can be transported to an internet connected computer, be updated and then be returned to the computer which does not have an internet connection. In case a network appliance 1014 is used in place of the secure device 1010, then the network appliance is a computer which includes a memory and operating system which are not accessible or changeable by an end user.

In accordance with an embodiment, each secure device (whether hardware or software) can store additional information about each chip. This information can include: (i) a digital watermark uniquely identifying the issuer; (ii) a global expiration date; (iii) a time period of license after activation; (iv) a license server; and (v) a name of the company to whom the chips are sold (purchaser information). This information can be encrypted similarly to the chips themselves. If unused chips (i.e., chips which have not yet been activated) are traded or resold, then this information can be updated with the new buyer information. This way, the license manager can verify that these chips are available to the new user and a chain of title can be tracked from issuance to use, from seller to ultimate end user.

As noted above, when the user needs to purchase new chips, or trade chips, the user can connect via an external network 1020, such as the internet, to a remote server 1022 which can include one or more brokers 1024. The one or more brokers 1024 can then update the secure device 1010 or the network appliance 1014. In accordance with an embodiment, the secure device 1010 or the network appliance 1014 can establish an authorized connection to the remote server 1022 which can authorize the new chip pool. For example, the new chip pool can be encrypted to prevent tampering by the user, then when new chips are added, assigned, reassigned or traded, the security mechanism can connect to a remote server and obtain authorization keys that enable the new chips pool to be reprogrammed (i.e., add newly purchased chips, assign chips, or reassign and trade chips).

In accordance with an embodiment, a security key can be associated with each broker 1024, and each broker can use its associated security key to encrypt the chips it sells or transfers. A broker can be provided by the software manufacturer which produces a particular software tool, in which case chips for that tool can be purchased directly from the software manufacturer using the manufacturer's broker. Additionally, or alternatively, independent brokers can be licensed by one or more software manufacturers can sell or transfer chips for a plurality of different software tools. These independent brokers can also facilitate trades of chips between different parties. Additionally, or alternatively, a single central broker can be provided by the VTBL system. Such a single central broker can sell and transfer chips for any software tool which can be used with the VTBL system.

In accordance with an embodiment, chips, which are available for trade or sale in a marketplace, can be valued based on the information stored in the secure device. For example, just as chip values may vary depending on the type of software tool they are associated with, chips which are soon to expire may be worth less than chips which have a longer life. Rather than setting values centrally by a particular broker, making the additional information about each chip available, allows the valuation of each chip to be decentralized and determined by the market. In such an environment, manufacturer-specific and independent brokers compete for transactions based on chip price, transaction fees, etc. Alternatively, a VTBL system broker can centrally manage and set prices at particular values depending on a valuation of the chip. In this environment, chips can be purchased, traded and sold at set rates through the VTBL system broker.

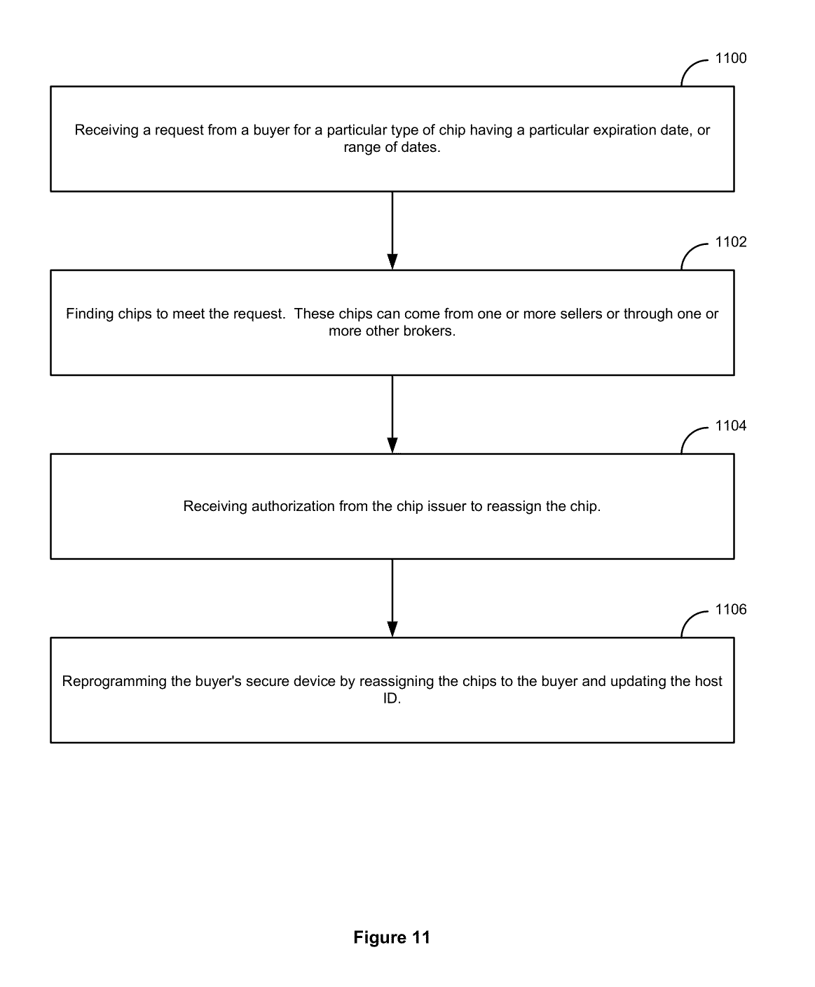

FIG. 11 shows a method for managing chips by a broker 1024, in accordance with an embodiment. At step 1100, a broker receives a request from a buyer for a particular type of chip having a particular expiration date, or range of dates. At step 1102, the broker finds chips to meet the request. These chips can come from one or more sellers or through one or more other brokers. At step 1104, the broker 1024 gets authorization from the chip issuer to assign the chip. At step 1106, the broker reprograms the buyer's secure device 1010 or the network appliance 1014 by assigning the chips to the buyer and updating the host ID.

In accordance with an embodiment, a chip audit mechanism 1026 can provide authentication, traceability, expiration date verification, and an activation check. The chip audit mechanism 1026 can query the secure device 1010 or the network appliance 1014 and output a data structure with the desired information. A particular audit can be run for a limited subset of information, for example check expiration dates, or for a full report. Additionally, the output of the audit can be in any number of standards-compliant data formats from which the user may choose. The output can indicate whether the chip is “authentic” based on the digital watermark, number of chips issued, number remaining, global expiry date, and other information. The chip audit mechanism can also check the system/bios clocks as well as the time stamps of files being operated on (in case the system/bios clock has been tampered with). In case of discrepancies, the software can be de-activated.

In accordance with an embodiment, to protection against counterfeiting, to ensure expiration of the chips on the appropriate expiration date, and to prevent tampering with the expiration date, chips can be encrypted in their entirety or can include an encrypted section that details the contract related data (original date of contract, date of chip issue, digital watermark, unique serial number for the chip).

Although the present invention has been described above with particularity to the field of electronic design automation (EDA) software and EDA licensing and license managers, it can equally be applied to any type of software and software licensing environment.

The present invention can be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a computer readable storage medium (media) having instructions stored thereon/in which can be used to program a computer to perform any of the processes of the present invention. The computer readable storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. Particularly, other GUIs and metrics for analyzing cost, complexity and usage statistics can be used. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A security system for a software licensing system, comprising:
a secure device, including a first computer readable medium, configured to connect to a computer, including a second computer readable medium and microprocessor;
wherein the secure device includes:
a chips pool which stores inactive chips, and
a chips accounting manager, operable to receive license requests for software tools and to determine whether to grant the license request;
a license server, executing on the computer;
wherein the license server include:
a license manager which tracks active chips and manages activated chip check-in and checkout, and
a chips cache which stores activated chips.

2. The security system for a software licensing system of claim 1 wherein the secure device is encrypted using a security key associated with an issuer of the secure device.

3. The security system for a software licensing system of claim 1, further comprising:
a broker, executing on a remote server, accessible to the secure device via an external network, wherein the broker is operable to:
receive a request for one or more new chips,
find the one or more new chips to meet the request,
receive authorization from a chip issuer to assign the one or more new chips, and
reprogram the secure device by assigning the chips to the secure device.

4. The security system for a licensing system of claim 3 wherein assigning the chips to the secure device includes updating a host ID for the chips.

5. The security system for a software licensing system of claim 1 wherein the secure device stores information for each chip, including:
a digital watermark uniquely identifying an issuer;
a global expiration date;
a time period of license after activation;
a license server; and
purchaser information.

6. The security system for a software licensing system of claim 4 further comprising:
a chip audit mechanism operable to query the secure device and output a data structure which includes information for each chip requested by the audit mechanism.

7. A method of providing security for a software licensing system, comprising:
providing a secure device, including a first computer readable medium, configured to connect to a computer, including a second computer readable medium and microprocessor;
enabling inactive chips to be stored in a chips pool on the secure device;
providing a chip accounting manager on the secure device, which receives license requests for software tools and determines whether to grant the license request;
providing a license server, executing on the computer;
providing a licensing manager on the license server, which tracks active chips and manages activated chip check-in and checkout; and
enabling activated chips to be stored in a chips cache on the license server.

8. The method of claim 7 further comprising:
encrypting the secure device using a security key associated with an issuer of the secure device.

9. The method of claim 7, further comprising:
receiving a request at a broker to update the secure device, wherein the broker receives a request for one or more new chips,
finds the one or more new chips to meet the request,
receives authorization from a chip issuer to assign the one or more new chips, and
reprograms the secure device by assigning the chips to the secure device.

10. The method of claim 9 wherein assigning the chips to the secure device includes updating a host ID for the chips.

11. The method of claim 7, further comprising:
receiving via an internet at a remote server a request to update the secure device, wherein the remote server includes a broker which:
receives a request for one or more new chips,
finds the one or more new chips to meet the request,
receives authorization from a chip issuer to assign the one or more new chips, and
reprograms the secure device by assigning the chips to the secure device.

12. The method of claim 7 further comprising enabling the secure device to store information for each chip, including one or more of a digital watermark uniquely identifying an issuer, a global expiration date, a time period of license after activation, a license server, and purchaser information.

13. The method of claim 11 further comprising:
auditing the secure device by querying the secure device and outputting a data structure which includes information for each chip requested in the audit.

14. A method of providing security for a software licensing system, comprising:
providing a secure device, including a first computer readable medium, configured to connect to a computer, including a second computer readable medium and microprocessor;
enabling inactive chips to be stored in a chips pool on the secure device;
providing a chip accounting manager on the secure device, which receives license requests for software tools and determines whether to grant the license request;
providing a license server, executing on the computer;
providing a licensing manager on the license server, which tracks active chips and manages activated chip check-in and checkout;
enabling activated chips to be stored in a chips cache on the license server; and
receiving via an internet at a remote server a request to update the secure device, wherein the remote server includes a broker which
receives a request for one or more new chips,
finds the one or more new chips to meet the request,
receives authorization from a chip issuer to assign the one or more new chips, and
reprograms the secure device by assigning the chips to the secure device.

15. The method of claim 14 wherein the updates to the secure device are received from a remote server by communicating with the remote server over an internet.

16. The method of claim 14 further comprising enabling the secure device to store information for each chip, including one or more of a digital watermark uniquely identifying an issuer, a global expiration date, a time period of license after activation, a license server, and purchaser information.

17. The method of claim 16 further comprising:
auditing the secure device by querying the secure device and outputting a data structure which includes information for each chip requested in the audit.

18. The method of claim 14 further comprising:
encrypting the secure device using a security key associated with an issuer of the secure device.

19. A method of remotely updating a secure device in a software licensing system, comprising:
receiving a remote request via an internet to update a secure device from a software licensing system, wherein the a secure device includes a first computer readable medium, and is configured to connect to a computer in the software licensing system, which includes a second computer readable medium and microprocessor;
passing the request to a broker which is operable to:
receive a request for one or more new chips,
find the one or more new chips to meet the request,
receive authorization from a chip issuer to assign the one or more new chips, and
reprogram the secure device by assigning the chips to the secure device; and
sending a response to the software licensing system, via the internet, responsive to the remote request to update the secure device.

20. The method of claim 19 wherein the software licensing system is operable to:
store inactive chips in a chips pool on the secure device;
receive license requests for software tools and to determining whether to grant the license request by a chip accounting manager on the secure device;
provide a license server, executing on the computer;
track active chips and managing activated chip check-in and checkout by a licensing manager on the license server; and
store activated chips in a chips cache on the license server.

21. The method of claim 19 further comprising:
receiving a request, at the broker, to trade one or more chips stored on the secure device;
valuing the one or more chips based on information about the one or more chips stored on the secure device; and
identifying a trading partner for the one or more chips.

22. The method of claim 19 further comprising associating the broker with a security key and encrypting chips sold or transferred by the broker.

23. A security system for a software licensing system, comprising:
a secure device, including a first computer readable medium, configured to connect to a computer, including a second computer readable medium and microprocessor;
wherein the secure device includes:
a chips pool which stores inactive chips, and
a chips accounting manager, operable to receive license requests for software tools and to determine whether to grant the license request;
a license server, executing on the computer;
wherein the license server includes
a license manager which tracks active chips and manages activated chip check-in and checkout, and
a chips cache which stores activated chips; and
a broker, executing on a remote server, which can communicate with the secure device, wherein the broker manages purchases, sales and transfers of chips for the secure device and centrally values each chip for purchase, sale or transfer based on information stored about each chip in the secure device.

24. The security system for a software licensing system of claim 23 wherein the broker identifies different secure devices with which to conduct the purchases, sales and transfers of chips and reprograms each secure device accordingly to reflect the purchases, sales and transfers of chips.

25. The security system of claim 1 wherein said secure device includes at least one of:
a secure device that connects to the license server through a computer port, or that is stored or executes on the license server;
a network appliance that is independent of the license server and communicates with the license server through a local area network; or
a network appliance that is located on a remote server or a remote server on an internet cloud device, and communicates with the licenser server.

26. The method of claim 7 wherein said step of providing the secure device includes at least one of:
providing a secure device that connects to the license server through a computer port, or that is stored or executes on the licenser server;
providing a network appliance that is independent of the license server and communicates with the license server through a local area network; or
providing a network appliance that is located on a remote server or a remote server on an internet cloud device, and communicates with the license server.

27. The method of claim 19 including a step of providing the secure device, wherein said step of:
providing a secure device that connects to the license server through a computer port, or that is stored or executes on the licenser server;
providing a network appliance that is independent of the license server and communicates with the license server through a local area network; or
providing a network appliance that is located on a remote server or a remote server on an internet cloud device, and communicates with the license server.

28. The security system of claim 23 wherein said secure device includes at least one of:
a secure device that connects to the license server through a computer port, or that is stores or executes on the license server;
a network appliance that is independent of the license server and communicates with the license server through a local area network; or
a network appliance that is located on a remote server or a remote server on an internet cloud device, and communicates with the licenser server.
